(19) United States
(12) Patent Application Publication
(10) Pub. No.: US 2025/0083201 A1
(43) Pub. Date: Mar. 13, 2025

(54) SYSTEM OF LANDFILL GAS EXTRACTION USING ROOT PIPE

(71) Applicant: Kennesha GARG, Fremont, CA (US)

(72) Inventor: Kennesha GARG, Fremont, CA (US)

(21) Appl. No.: 18/882,779

(22) Filed: Sep. 12, 2024

Related U.S. Application Data
(60) Provisional application No. 63/538,079, filed on Sep. 13, 2023.

(51) Int. Cl. B09B 1/00; G01F 23/296

(52) U.S. Cl. CPC B09B 1/006; G01F 23/2961

(57) ABSTRACT

The present invention relates to a landfill gas extraction system (100) inspired by mangrove root systems, significantly improving methane extraction rates in landfills. The system (100) comprises plurality of root pipes (101) as extensions to efficiently collect methane gas from remote areas, reducing methane clustering and mitigating explosion and landfill fire risks. The system (100) further comprises the plurality of stems (102, the vertical pipes extending from the landfill bottom to top, and plurality of junctions (103) with plurality of detachable caps (104), serving as connection points for additional extensions of the root pipe (101). Additionally, plurality of ultrasonic sensors (105) facilitates alerting the operator when the waste reaches the junction (103) for the root pipe (101) integration. The system (100) facilitates landfill gas extraction, making waste management safer and eco-friendly.

### PRIORITY CLAIM

This application claims priority from the provisional application No. 63/538,079 filed with US Patent Office on 13 Sep. 2023 titled “A system of landfill gas extraction using root pipe”, the entirety of which is expressly incorporated herein by reference.

### DESCRIPTION OF THE INVENTION

### Technical Field of the Invention

The present invention relates to a landfill gas extraction system designed to achieve augmented rates of methane extraction, thereby addressing the efficient management of methane, a potent greenhouse gas prevalent within landfill environments. Specifically, the invention pertains to a novel extraction system that takes inspiration from the intricate root systems exhibited by mangroves, thereby contributing to an effective waste management and environmental conservation.

### Background of the Invention

The management of solid waste through landfills has been a prevalent waste disposal practice for decades. Nevertheless, this method entails notable environmental complexities, primarily attributed to the release of methane gas. Methane, a potent greenhouse gas, plays a significant role in global warming and climate change. Notably, landfills contribute approximately 17% of total methane emissions in the United States. The urgent environmental issue emphasizes how important it is to find practical ways to reduce landfill methane release and lessen its negative effects on the ecosystem.

Current landfill extraction systems predominantly rely on conventional horizontal and vertical pipes to capture methane produced during the decomposition of organic waste. Despite their intentions, these systems suffer from several limitations that impede comprehensive gas collection and efficient methane mitigation.

One of the primary drawbacks of conventional extraction systems is their inability to effectively capture methane from hard-to-reach or remote areas within the landfill. As a result, significant amounts of methane escape into the atmosphere, exacerbating the environmental impact and contributing to the phenomenon of climate change.

Moreover, the limited coverage of these extraction systems leaves certain regions of the landfill inadequately monitored, making them susceptible to methane leaks. This deficiency in comprehensive gas collection not only leads to increased methane emissions but also poses potential safety hazards within the landfill.

Furthermore, the existing landfill extraction technologies may not effectively prevent methane seepage into surrounding soil and groundwater, contributing to environmental contamination and adversely affecting local ecosystems.

Additionally, the inefficiency of conventional extraction methods often leads to the accumulation of methane within the landfill, increasing the risk of explosive situations and landfill fires, thus posing severe threats to both the environment and surrounding communities.

The Patent Application No. CN218743858U entitled “Gas pumping and discharging system of refuse landfill” discloses a gaseous pump drainage system for refuse landfills, featuring a buried collection well in the landfill area with an upper pumping device. The well comprises a vertically arranged gas pumping and discharging pipe and a condensate collecting sleeve, including outer and inner pipe walls with a solid bottom plate. The outer pipe's upper end connects to the gas pipe's base, incorporating an opening, while the inner pipe's inner side is hollow for communication between the gas pipe and the landfill. A condensate guiding pipe is connected to the outer pipe's base. This innovative system optimizes landfill gas overflow, utilizes solar energy for efficient gas pumping, and prioritizes cost-effectiveness and environmental sustainability. The system efficiently enhances landfill gas overflow, utilizing solar energy for pumping power, offering an economical and environment-friendly approach to gas extraction in landfills.

The U.S. Pat. No. 11,602,777B2 entitled “Devices and techniques relating to landfill gas extraction” discloses a control system for landfill gas extraction that comprises at least one sensor measuring landfill gas characteristics, at least one flow control mechanism in the well piping regulating gas flow, and at least one processor. The processor obtains the measured concentration of a first gas in the landfill gas, determines if it's below a first threshold or above a second threshold concentration. When the concentration is below the first threshold, the flow control mechanism reduces the gas flow rate, and when it exceeds the second threshold, the flow control mechanism increases the gas flow rate. This system optimizes landfill gas extraction based on real-time gas concentration measurements, ensuring efficient and controlled gas extraction from the landfill.

The U.S. Pat. No. 11,273,473B2 entitled “Landfill gas extraction systems and methods” discloses a control system designed to manage the extraction of landfill gas from a landfill via a gas extraction system, which includes well piping connecting several wells to a gas output. The system comprises a controller responsible for obtaining and comparing the measured energy content of landfill gas collected from the output with a target energy content. If there is a disparity between the measured and target energy content, the controller takes action by adjusting the flow rates of landfill gas extracted from some of the wells. This adjustment is achieved by controlling a series of valves within the well piping, varying the degrees to which the valves are open. This dynamic control mechanism ensures that the gas extraction process optimizes the energy content of the collected landfill gas, enhancing the efficiency of the overall landfill gas extraction system.

The existing prior arts discuss different landfill gas extraction methods, but none of them addresses the challenge of reaching more areas to collect trapped gas effectively. Hence, there is a need for a system that overcomes the drawbacks of the existing systems and the prior arts, thereby providing an innovative system that aims to revolutionize landfill gas extraction by efficiently accessing and collecting trapped gas from remote and challenging locations within the landfill.

In conclusion, despite the advancements in landfill technology and the progress made in waste management practices, certain gaps persist within the field. Thus, there is a compelling need for an innovative solution that effectively bridges the deficiencies prevalent in the current landfill gas extraction landscape and optimizes the gas extraction process within landfills for a more sustainable future.

### SUMMARY OF THE INVENTION

The present invention provides a system for landfill gas extraction, wherein the system comprises a plurality of root pipes (101) enabling methane extraction in landfill management, wherein the root pipe (101) acts as an extension to efficiently extract methane gas from remote and inaccessible areas within landfills. The root pipe (101) is structurally designed in the form of mangrove roots, that can easily penetrate through remote areas. The system (100) further comprises at least one stem (102) containing a plurality of junctions (103) that are integrated within a singular horizontal layer coinciding with the stem (102). The stem (102) is the vertical pipe structure that extends from the bottom to the top of the landfill, providing a network of channels for gas extraction. The junction (103) comprises a detachable cap (104), wherein the detachable cap (104) functions as a point of connection for prospective extensions of the root pipe (101).

The system (100) further comprises an ultrasonic sensor (105), wherein the post installation of the ultrasonic sensor (105) with the system (100) that are employed in multiple units, helps alerting the operator upon the gases reaching the junction (103), facilitating enhancement of the feasibility in new landfill contexts. The ultrasonic sensor (105) continuously measures the waste level by measuring the distance between the ultrasonic sensor (105) and the waste. When the ultrasonic sensor (105) detects the proximity of the waste close to the junction (103), an alert is sent to the landfill operator, through a software integrated with the system (100). Upon receiving real-time notification from the ultrasonic sensor (105), the landfill operator proceeds with the root pipe installation, wherein the detachable caps (104) from the junctions (103) right above the waste level are removed and the root pipes (104) are attached to the junctions (103) ensuring precise placement for optimal gas extraction.

According to the invention, at the time of installation of the root pipes (101),

the detachable caps (104) from the junctions (103) are removed, and the root pipes (101) are connected with the stems (102) through the junctions (103) for optimal gas extraction. The installation process allows for uninterrupted waste disposal. Once the root pipes (101) are attached, the waste disposal can proceed without interference, making the system efficient and compatible with ongoing landfill operations.

According to the invention, the root pipe (101) function as extensions, reaching deep into the landfill to tap into methane-rich pockets that would otherwise be challenging to extract with conventional systems. By emulating the efficiency of mangrove roots, the root pipe (101) ensures enhanced gas extraction. The system (100) optimizes methane extraction efficiency by capturing the methane gas from the landfills, where the reduction in methane emissions significantly reduces the risk of explosions and landfill fires.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIGS. 1a-1d illustrate a plurality of distinct directional views of the system, in accordance with an embodiment of the present invention.

FIGS. 2a-2d illustrate a plurality of distinct directional views of the system, in accordance with another embodiment of the present invention.

FIGS. 3a-3c illustrate a plurality of distinct directional views of the system, in accordance with yet another embodiment of the present invention.

FIGS. 4a-4c illustrates the directional views of an alternative embodiment of the present invention.

FIG. 5a illustrates the graphical representation of the pressure of the compost in the first box and the second box over time.

FIG. 5b illustrates the graphical representation of the temperature of the compost in the first box and the second box over time.

FIG. 5c illustrates the graphical representation of the methane concentration in the first box and the second box over time.

FIG. 6a illustrates the graphical representation of pressure of the landfill system with respect to time.

FIG. 6b illustrates the graphical representation of accumulated pressure of the landfill system with respect to time.

### DETAILED DESCRIPTION OF THE INVENTION

In order to describe and point out the subject matter of the claimed invention, the following definitions are provided for specific terms, which are used in the following written description more clearly and concisely.

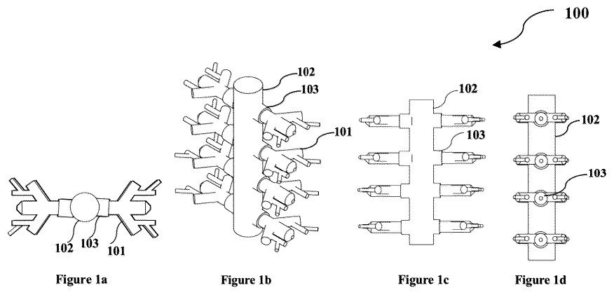

FIGS. 1a-1d illustrate a plurality of distinct directional views of the of the system (100), in accordance with an embodiment of the present invention. The system (100) of landfill gas extraction comprises a plurality of root pipes (101), offering an innovative and eco-friendly approach to methane extraction and safety in landfill management. In one embodiment, the present invention is visually represented through multiple perspectives of the system (100). Specifically, [FIG. 1a], [FIG. 1b], [FIG. 1c], and [FIG. 1d] respectively depict the top view, side view, cross-sectional view, and front view of the system (100).

The system (100) utilizes the root pipes (101) as extensions to efficiently extract methane gas from remote and challenging areas within landfills by drawing inspiration from the adaptive nature of mangrove roots. The system (100) comprises a plurality of stems (102), further comprising a plurality of junctions (103) that are integrated within a singular horizontal layer coinciding with the stems (102). The stem (102) is installed vertically that extends from the bottom to the top of the landfill, providing a network of channels for gas extraction. The junction (103) further comprises a detachable cap (104), wherein the detachable cap (104) functions as a point of connection for prospective extensions of the root pipe (101).

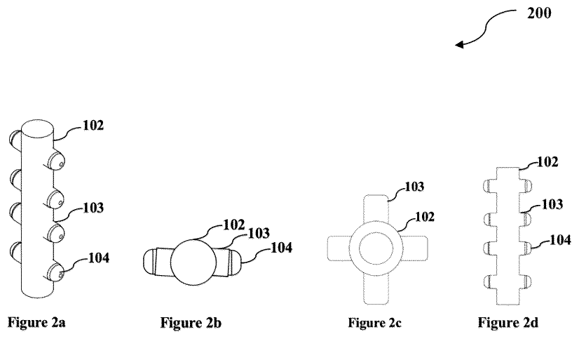

FIGS. 2a-2d illustrate a plurality of distinct directional views of the of the system, in accordance with another embodiment of the present invention. The system (100), before installation of the root pipe (101) is disclosed. In one embodiment, the present invention is visually represented through multiple perspectives of the system (100). Specifically, [FIG. 2a], [FIG. 2b], [FIG. 2c], and [FIG. 2d] respectively depict the front view with two junctions, side view with two junctions, top view with four junctions, and cross-sectional view with two junctions of the system (100). At the time of installation of the root pipe (101), the detachable cap (104) is removed, and the root pipe (101) is connected with the stem (102) through the junction (103).

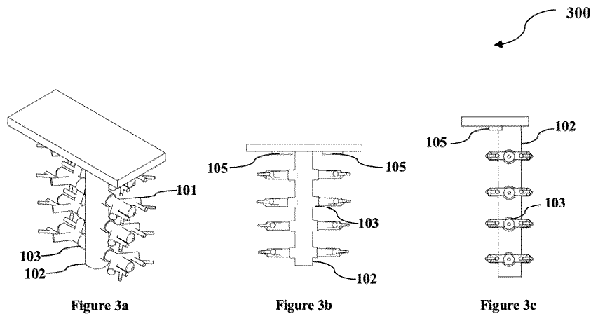

FIGS. 3a-3c illustrate a plurality of distinct directional views of the system, in accordance with yet another embodiment of the present invention. The system (100) after installation of plurality of ultrasonic sensors (105). Specifically,

[FIG. 3a], [FIG. 3b], and [FIG. 3c] respectively depict the perspective view, cross sectional view and the side view of the system (100). The system (100) after installation of plurality of ultrasonic sensors (105), employed in multiple units, enhance feasibility in new landfill contexts, alerting operators upon waste reaching predetermined junctions (103) intended for integration with the root pipes (101).

As the waste is added in the landfills, the ultrasonic sensor (105) continuously measures the height of the waste by measuring the distance between the ultrasonic sensor (105) and the waste. When the ultrasonic sensor (105) detects the proximity of the waste close to the junction (103), an alert is sent to the landfill operator, through a software integrated with the system (100). Upon notification to the operator, the operator removes the detachable cap (104) from all the junctions (103) located right above the waste level and attaches the root pipes (101) to all the junctions (103). Upon attachment of a plurality of root pipes (101) at the junctions (103), adding more waste into the landfill resumes. The installation process allows for uninterrupted waste disposal. Once root pipes (101) are attached, waste disposal can proceed without interference, making the system efficient and compatible with ongoing landfill operations.

The core feature of the system (100) involves root pipes (101), which acts as additional channels for methane extraction. Inspired by mangrove roots, that have evolved to effectively access oxygen in waterlogged soils through pneumatophores, the root pipes (101) in the system (100) function as extensions, reaching deep into the landfill to tap into methane-rich pockets that would otherwise be challenging to extract with conventional systems. By emulating the efficiency of mangrove roots, the root pipes (101) ensure enhanced gas extraction from even the most inaccessible areas of the landfill.

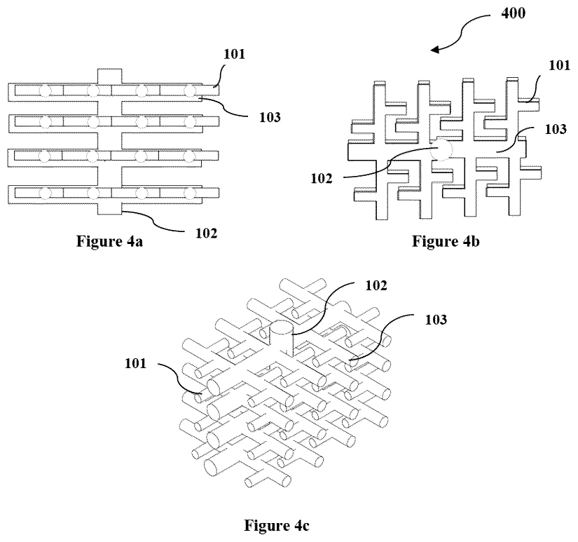

FIGS. 4a-4c illustrates the directional views of an alternative embodiment of the present invention. With reference to FIGS. 4a-4c, the sectional view, top view and perspective view of the system (100) is disclosed, wherein the system (100) comprises the stem (102) with a plurality of junctions (103) consisting at least one root pipe (101) as extensions to efficiently extract methane gas from inaccessible areas. The root pipe (101) is positioned at right angle with respect to the junction (103), facilitating increase in extraction of methane from the landfills or any area where the system (100) is installed.

The system (100) optimizes methane extraction efficiency by capturing gas from previously overlooked areas. The reduction in methane emission significantly contributes to greenhouse gas emission reduction efforts. The system (100) helps mitigate the formation of methane clusters within the landfill, significantly reducing the risk of explosions and landfill fires, and thus enhances overall safety for landfill operators and nearby communities.

The method for optimizing methane gas extraction in the landfill through the system (100) comprises the steps of: installation of the system (100) in regions of the landfill with high methane concentration, where the ultrasonic sensor (105) facilitates monitoring the waste levels, and when the waste levels reaches close to the junctions (103), the ultrasonic sensor (105) alerts the operator through the software integrated with the system (100), and the root pipes (101) are attached to the junctions (103), after the removal of the detachable caps (104), allowing for precise methane gas extraction.

The efficiency of the system (100) can be studied in detail using several examples. According to an embodiment of the invention, the level of methane concentration, the pressure levels and the temperature levels were determined throughout the duration of the experiment, in order to determine the efficiency of the system in extracting methane gas from landfill.

### Example 1: Small Scale Experimentation by Creating Two Landfill Environments Inside Airtight Boxes

The efficiency of the root pipes (101) was determined in small scale by simulating a typical landfill environment. In order to test the efficacy and functionality of the root pipe (101) having mangrove-like design, the system was 3D-printed, and two landfill environments were created inside airtight boxes, wherein the first box was installed with the system (100), and the second box contained a singular pipe, which emulates the current landfill system.

Further, both the boxes, i.e., the first box and the second box were filled with 10 kilograms of identical compostable waste, and a layer of foil was used to separate the compostable waste from the empty space in the boxes. The environment in the boxes promote the creation of compost, generating methane and carbon-dioxide gases, where the foil barrier acts as a “cap” that is present in large scale landfills. In addition, the foil blocks most gases from escaping into the empty space, thus facilitating the prevention of leakage of gases and directing them only through the root pipes (101). Upon setting up the first box and the second box, a pressure gauge is used to measure the pressure created in each box, documenting the amount of gas accumulated in the empty space over time. As the gases collect in the empty space through the pipes, the pressure of each box gradually increases over time.

According to the invention, the pressure is recorded every 5 days, and in order to ensure that there is a minimum amount of oxygen entering the boxes and a minimum amount of methane exiting the boxes during data collection, a pressure valve installed on the lid of each box facilitates recording the pressure values. Further, the temperature of the compost is also periodically measured with the help of temperature sensor installed at the bottom of the box. The increase in temperature indicates the increased amount of methane trapped in the compost. Additionally, a methane detection meter is used to measure the concentration of methane in the empty space of the boxes. The concentration of methane in both the boxes is identical, as the amount of methane collected is proportional to the total amount of gases collected.

The duration of the experimentation spanned for around five months to allow the waste to decompose and generate ample methane, carbon-dioxide, and other gases.

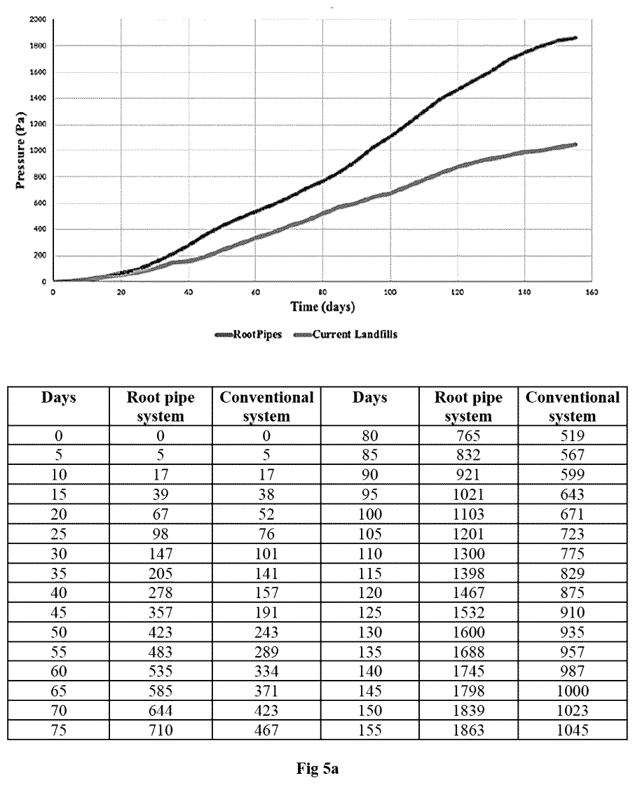

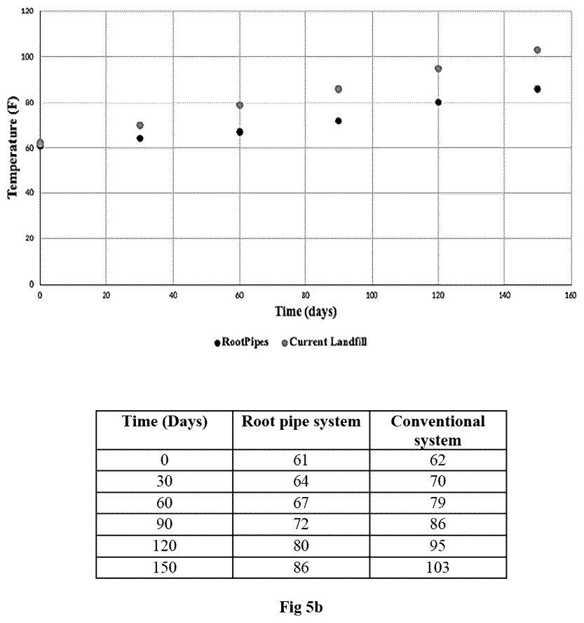

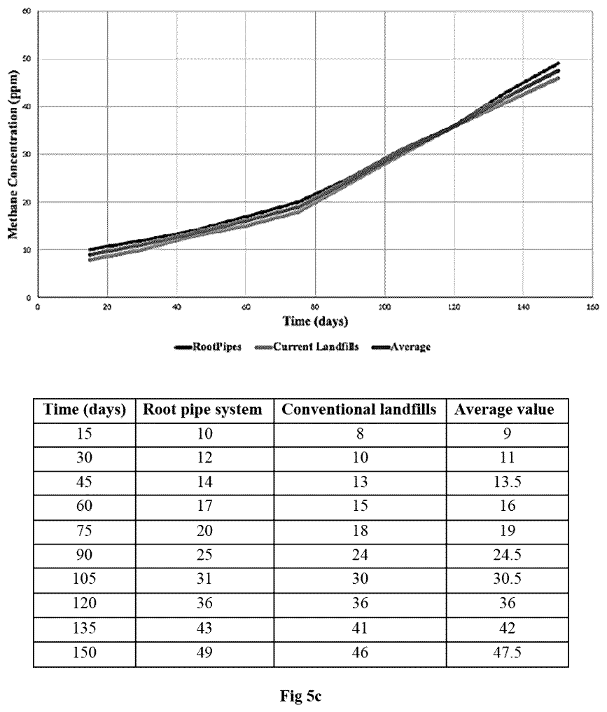

FIG. 5a illustrates the graphical representation of the pressure of the compost in the first box and the second box over time. The pressure of the compost in both landfills was recorded every 5 days. It was determined that the pressure of the compost in the first box was higher compared to the pressure of the compost in the second box, as disclosed in the FIG. 5a. The pressure in the first box and the second box was equal at the beginning, as no gases were formed and transferred yet. Over time, the first box containing root pipes (101) showed increase in the pressure than the second box containing conventional methane extracting system, ultimately displaying a drastic difference in gas pressure in the first box compared to the second box. It was found that the system (100) in the first box transferred around 79% more gas than the second box.

FIG. 5b illustrates the graphical representation of the temperature of the compost in the first box and the second box over time. The temperature of the compost in both landfills was recorded every 30 days. The temperature of compost in the second box was higher than the temperature of compost in the first box with root pipe (101).

FIG. 5c illustrates the graphical representation of the methane concentration in the first box and the second box over time. The methane concentration of both landfills was recorded every 15 days. It was determined that the concentration of methane gas in the first box was higher compared to the second box, indicating that the root pipe (101) facilitates extraction of more amount of methane as compared to the conventional systems.

Therefore, the system (100) facilitates collection of more gases due to their ability to reach remote areas of the landfill. In a large-scale landfill system, more than one root pipe (101) is required to be installed, and the stems will increase the amount of landfill gas (LFG) collected. Scaling the above result to an actual landfill discloses that around 91% of LFG will be collected, and around 9% of LFG will be emitted with the system (100) as compared to the conventional landfill systems that emit around 46% and collection of LFG around 54%. The methane concentrations were equal in both the first box and second box at the start of the experiment, however the concentrations were lower, suggesting that large amounts of other gasses, such as carbon dioxide, were also present in the landfills.

### Example 2: Large Scale Experimentation at a Farm

Two landfill system set-ups were created at a farm, wherein the first set-up comprises the root pipe (101) structure and the second set-up comprises the conventional pipe structure currently used in the landfills. Both the pipe structures were submerged under compost piles consisting of animal feces, food waste, etc., and both the piles were covered with tarp to prevent any escape of gases after decomposition, in order to promote uptake of gases in the central pipe. The gases that flow through the central pipe are channeled into an inflatable ball, and the pressure within the ball is measured with a pressure gauge that is connected to a provision on the ball. Upon data collection, the valve at the top is opened to release the gases from the ball, allowing for the system to be reset for subsequent uptake measurements.

Furthermore, the humidity levels were measured on a scale from 1 to 10, with 1 signifying an overly dry pile and 10 indicating excessive wetness. A sprinkler system was installed among the pile to moisten the compost and elevate humidity levels when the moisture level decreases. The humidity for both piles was meticulously controlled at a mid-range value of 5 to eliminate any confounding factors. Further, in order to determine and compare the efficacy of biogas generation between the two piles methane concentrations were monitored through a valve. The study spanned for four months and all the variables were measured and recorded every 5 days.

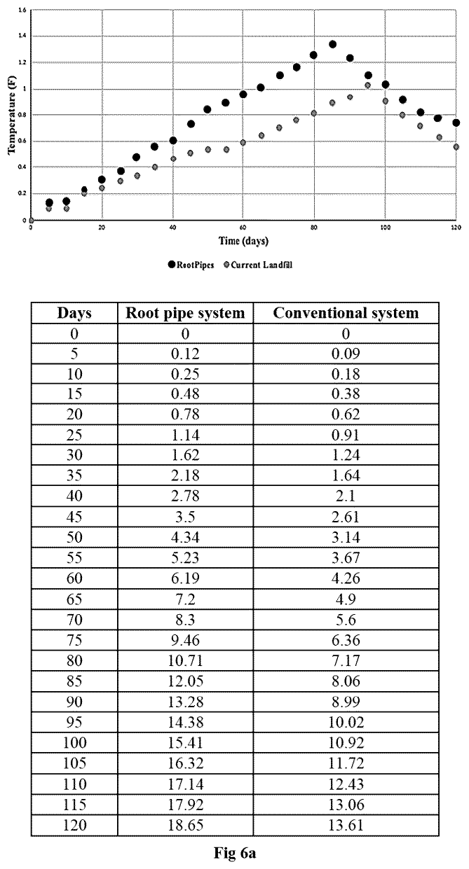

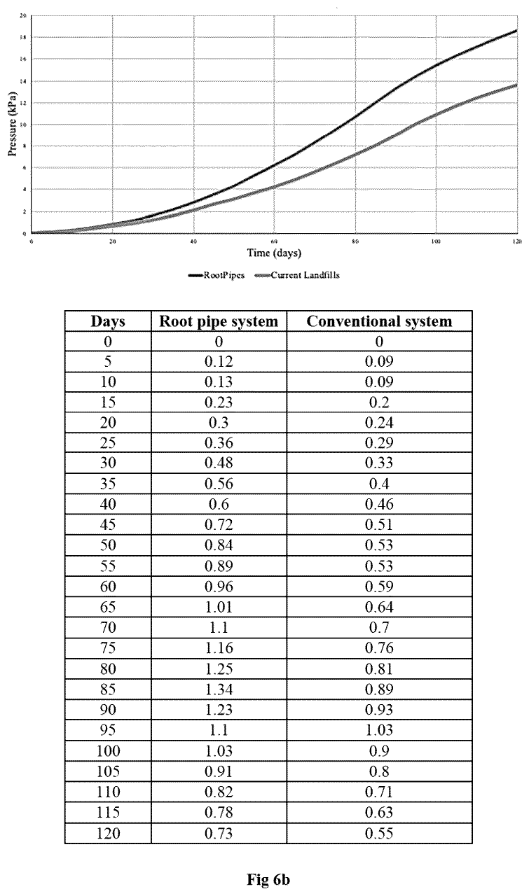

FIG. 6a illustrates the graphical representation of pressure of the landfill system with respect to time. The pressure graph disclosed that the pressure of the inflatable ball recorded after each reset. It was determined that over time, the landfill comprising root pipes (101) accumulated more pressure than the conventional landfill.

FIG. 6b illustrates the graphical representation of accumulated pressure of the landfill system with respect to time. The pressure graph disclosed that the trend of the pressure after each new data is added to previous data collected. The system (100) with root pipes (101) collected around 37% more gases than the conventional landfill system.

The preliminary results indicated an increase in collection efficiency by 79% during small scale-study, and by 37% during large-scale study. The root pipe (101) system facilitates reduction in methane gas emissions attributed to current landfill practices by adhering to the established criteria in the above examples. Implementing the system (100) with root pipe (101) on a larger scale has the potential to significantly curtail methane emissions from landfills in the United States and globally. The adaptation of the system (100) in the landfills is a critical stride towards reducing environmental impact, thus contributing to a more sustainable future, and ensuring a better quality of life for coming generations.

The system of landfill gas extraction using root pipes (100) offers several significant benefits for landfill management and environmental sustainability. By maximizing methane extraction through its innovative extensions, the system (100) effectively reduces greenhouse gas emissions, contributing to global climate change mitigation efforts. The system's (100) modular design and operator-controlled attachment ensure precise and efficient placement, leading to enhanced landfill gas management and improved waste decomposition. Furthermore, the system (100) significantly lowers the risk of methane clustering, thereby minimizing the potential for explosions and landfill fires, promoting safety for both landfill operators and neighboring communities. With its adaptability and cost-effectiveness, the system (100) represents a promising solution for sustainable waste disposal practices, making it a pioneering step towards cleaner and safer landfill operations. Furthermore, the system (100) is adaptable to all conditions and through the enhanced collection, the landfill gas can be converted into renewable energy. Additionally, by utilizing the energy generated from landfill gas, there is potential to decrease reliance on non-renewable energy sources like fossil fuels and coal.

### REFERENCE NUMBERS

| Components | Reference Numbers |
|---|---|
| System | 100 |
| Root Pipe | 101 |
| Stem | 102 |
| Junction | 103 |
| Detachable Cap | 104 |
| Ultrasonic Sensor | 105 |

I claim:

1. A system for landfill gas extraction, the system (100) comprising:
a. a plurality of root pipes (101) configured to extract methane gas from one or more landfill regions, wherein the root pipes (101) extend to reach remote areas within the landfill;
b. a plurality of stems (102) vertically extending from the base to the top of the landfill, providing a network of channels for gas collection;
c. a plurality of junctions (103) integrated with the stem (102), wherein the junction (103) facilitates connection between the root pipe (101) and the stem (102), where the junction (103) further comprises a detachable cap (104) facilitating attachment of said root pipes (101); and
d. a plurality of ultrasonic sensors (105) integrated within the system to monitor waste levels in real time.

2. The system (100) as claimed in claim 1, wherein the root pipe (101) enables efficient gas extraction from inaccessible methane-rich pockets in the landfill.

3. The system (100) as claimed in claim 1, wherein the ultrasonic sensor (105) facilitates providing alert to the operator through a software integrated with the system (100), upon the waste level reaching close to the junction (103), enabling the controlled installation of the root pipe (101) for gas extraction.

4. The system (100) as claimed in claim 1, wherein the junction (103) is horizontally aligned with the stem (102) and is configured to allow extension of the gas extraction by attaching at least one additional root pipe (101).

5. The system (100) as claimed in claim 1, wherein the detachable cap (104) of the junction (103) is configured to be removed and reinstalled without disrupting the ongoing landfill operations, allowing for continuous waste disposal during the installation process.

6. The system (100) as claimed in claim 1, wherein the ultrasonic sensor (105) is configured to provide real-time data, allowing installation of at least one root pipe (101) directly above the landfill for methane gas extraction.

7. The system (100) as claimed in claim 1, wherein the root pipe (101) significantly reduces methane gas emissions into the atmosphere, enabling enhancement of environmental sustainability.

8. The system (100) as claimed in claim 1, wherein the method for optimizing methane gas extraction in a landfill comprises the steps of:
a. installation of the system (100) in regions of the landfill with high methane concentration;
b. utilizing an ultrasonic sensor (105) to monitor the waste levels;
c. attaching at least one root pipe (101) to the junctions (103) after the removal of the detachable caps (104), allowing for precise methane gas extraction.

9. The system (100) as claimed in claim 1, wherein the increase in efficiency of the system (100) in methane gas extraction from the landfills in small-scale is 79%.

10. The system (100) as claimed in claim 1, wherein the increase in efficiency of the system (100) in methane gas extraction from the landfills in large-scale is 37%.
